(19) United States
(12) Patent Application Publication
(10) Pub. No.: US 2024/0328166 A1
(43) Pub. Date: Oct. 3, 2024

(54) HAND RAIL

(71) Applicant: Kingsway Enterprises (UK) Limited, Swanley, Kent (GB)

(72) Inventor: Benjamin Hall, Swanley, Kent (GB)

(21) Appl. No.: 18/292,065

(22) PCT Filed: May 5, 2022
(86) PCT No.: PCT/EP2022/062118

§ 371 Date: Jan. 25, 2024

(30) Foreign Application Priority Data
Jul. 26, 2021 (GB) 2110695.0

(51) Int. Cl. E04F 11/18; B29C 41/04; B29L 22/00

(52) U.S. Cl. CPC E04F 11/1804; B29C 41/042; B29L 2022/00; E04F 2011/1897

(57) ABSTRACT

The present disclosure relates to a hand rail. The hand rail comprises an elongate handle and an attachment portion, the handle being connected to the attachment portion by a continuous connecting web that extends from a first end of the hand rail to a second end of the hand rail to define an elongate channel between the handle and the attachment portion, the channel being open at the first end of the handle and closed at the second end of the handle; wherein a base of the channel is sloped relative to the handle such that liquid drains out of the channel when the handle is in a horizontal orientation.

### RELATED APPLICATION

The present application is a national stage application under 35 U.S.C. § 371 of International Application No. PCT/EP2022/062118, filed 5 May 2022, which claims priority from Great Britain Patent Application No. 2110695.0, filed 26 Jul. 2021. The above-referenced applications are incorporated by reference.

### FIELD

The present disclosure relates to a hand rail for use in psychiatric hospitals.

### BACKGROUND

Wall-mounted hand rails are often used in psychiatric hospitals to help less able-bodied patients. In addition to providing help to less able-bodied patients, hand rails for use in psychiatric hospitals must also be designed in such a way that they prevent patients from causing themselves harm. For example, they must be designed in such a way that a ligature cannot be secured around them or to them. GB2505494 discloses a hand rail which eliminates certain ligature points. However, there exists a need for an improved hand rail for psychiatric hospitals which further improves safety and further eliminates ligature points.

### SUMMARY

At its most general, the present disclosure relates to a hand rail comprising:
an elongate handle and an attachment portion, the handle being connected to the attachment portion by a continuous connecting web that extends from a first end of the hand rail to a second end of the hand rail to form an elongate channel between the handle and the attachment portion, the channel being open at the first end of the handle and closed at the second end of the handle.

The provision of the continuous connecting web eliminates any gaps or openings between the handle and the attachment portion. Ligature points are thereby eliminated. Patient safety is thereby realised.

In a first aspect, a base of the channel is sloped relative to the handle such that liquid drains out of the channel when the handle is in a horizontal orientation. Accordingly, pooling of water or other liquids within the channel is prevented when the handle is mounted to a wall in a horizontal orientation. Hygiene, and thus patient safety, is thereby improved.

In a second aspect, the hand rail also includes a wall plate attached to the attachment portion, wherein the handle and attachment portion collectively comprise a first unitary part, and wherein the wall plate comprises a second unitary part attached to the first unitary part. The hand rail is therefore simple to manufacture, and simple to install. Cost per unit is therefore low.

In a third aspect, the handle and attachment portion collectively comprise a unitary part formed of plastic. The hand rail is therefore simple and inexpensive to manufacture. The hand rail is also lightweight, and warm to the touch. Plastic is also a preferred material in clinical environments, because it is easy to sanitise and does not corrode. Plastic is also preferred over metal, because it does not produce sharp and dangerous points when broken.

As the reader will understand, any combination of the first, second and/or third aspects is within the scope of the present disclosure.

Further optional features of the present disclosure are set out below.

The handle and attachment portion may be formed as a single (unitary) piece. For example, they may be formed by rotational moulding. Accordingly, they may comprise a unitary hollow plastic piece. Robustness is thereby improved. Weak points are eliminated. Speed of manufacture is increased, and cost of manufacture is decreased.

The hand rail may be for attachment horizontally to a wall, for example attachment to a wall with the handle oriented horizontally. In the following description, we'll describe features of the hand rail relative to such a horizontal orientation. In such an orientation, the hand rail can be considered as having a top edge extending between the first and second ends; and a bottom edge extending between the first and second ends.

The elongate channel may extend below the handle. For example, the base of the elongate channel may be positioned below the handle (e.g. below a mid-point of the handle). For example, the base of the elongate channel may be positioned below an axial mid-point of the handle. The base of the elongate channel may be lower at the first end of the channel than at the second end of the channel, thereby providing the drainage slope of the first aspect.

The top edge of the elongate handle may slope downwards towards the first end of the hand rail (i.e. slope downwards towards the open end of the channel). For example, the first end of the handle may have a top edge that slopes downwards towards the first end of the hand rail. Ligature points from the open end are thereby eliminated.

The underside of the hand rail may slope downwards towards the wall. For example, the underside of the hand rail may slope downwards from a front edge of the handle towards the attachment portion. The underside of the hand rail may be convex. Ligature points from the underside of the hand rail are thereby eliminated.

The cross-sectional width of the channel may taper towards the base of the channel. For example, the channel may taper from a largest width at its upper-most point, to a narrowest width at its lower-most point. The opposing side-walls of the channel may be non-parallel with one another. They may form an acute angle with one another. For example, the channel may be generally v-shaped in cross-section. Accordingly, wedging of a ligature within the channel is prevented.

The total length of the hand rail may taper towards a front edge of the elongate handle. For example, the hand rail may taper from a largest length adjacent the wall, to a shortest length at the front edge of the handle. It may, for example, have a rounded profile when viewed from above. Ligature points around the opposing ends of the hand rail are thereby eliminated.

The first end of the hand rail may be rounded. The second end of the hand rail may also be rounded.

The wall plate may be configured for attachment to a wall. For example, the wall plate may comprise a plurality of holes for attachment to a wall. The holes may be counter-sunk. The holes may be arranged along a perimeter of the wall plate.

The wall plate may have rounded, e.g. radiused, edges.

The attachment portion may be attached to the wall plate by threaded screws. Alternatively, the attachment portion may be attached to the wall plate by adhesive.

In a fourth aspect the present disclosure relates to a method of manufacturing a hand rail according to the first or third aspect by rotational moulding. The method may comprise:
filling a hollow mould with a charge of thermoplastic;
closing the mould;
heating the mould to melt the thermoplastic; and
cooling the mould while simultaneously rotating the mould, to thereby coat
the inner surfaces of the mould with the plastic.

It has been found that the unique shape of the hand rail according to the present disclosure can be achieved by forming the hand rail through rotational moulding. By contrast, the unique shape of the hand rail according to the present disclosure cannot be achieved through injection moulding e.g. of aluminium. For example, a hand rail with rounded first and second ends cannot be achieved through injection moulding e.g. of aluminium.

### BRIEF DESCRIPTION OF THE DRAWINGS

Examples of the present disclosure will now be described, by way of example only, with reference to the accompanying figures, in which:

FIG. 1 shows a perspective view of a hand rail according to a first embodiment;

FIG. 2 shows a front-view of the hand rail from FIG. 1;

FIG. 3 shows a top-view of the hand rail from FIG. 1;

FIG. 4 shows a bottom-view of the hand rail from FIG. 1;

FIG. 5 shows a first end-view of the hand rail from FIG. 1;

FIG. 6 shows a second end-view of the hand rail from FIG. 1;

FIG. 7a shows an exploded view of the hand rail according to FIG. 1;

FIG. 7b shows an assembled cross-sectional view of the hand rail according to FIG. 1;

FIG. 8 shows an exploded view of a hand rail according to a second embodiment;

FIG. 9 shows a side-view of the hand rail according to FIG. 8;

FIG. 10 is a flow diagram showing a method of manufacturing a hand rail according to the present disclosure;

FIG. 11 is a flow diagram showing an alternative method of manufacturing a hand rail according to the present disclosure;

FIG. 12 is a cross-sectional view of a hand rail formed by the method of FIG. 11, having threaded inserts embedded therein; and

FIG. 13 is a cross-sectional view of a threaded insert for use in a handrail according to FIG. 12.

Like reference numerals are used for like features and components throughout the drawings and detailed description.

### DETAILED DESCRIPTION

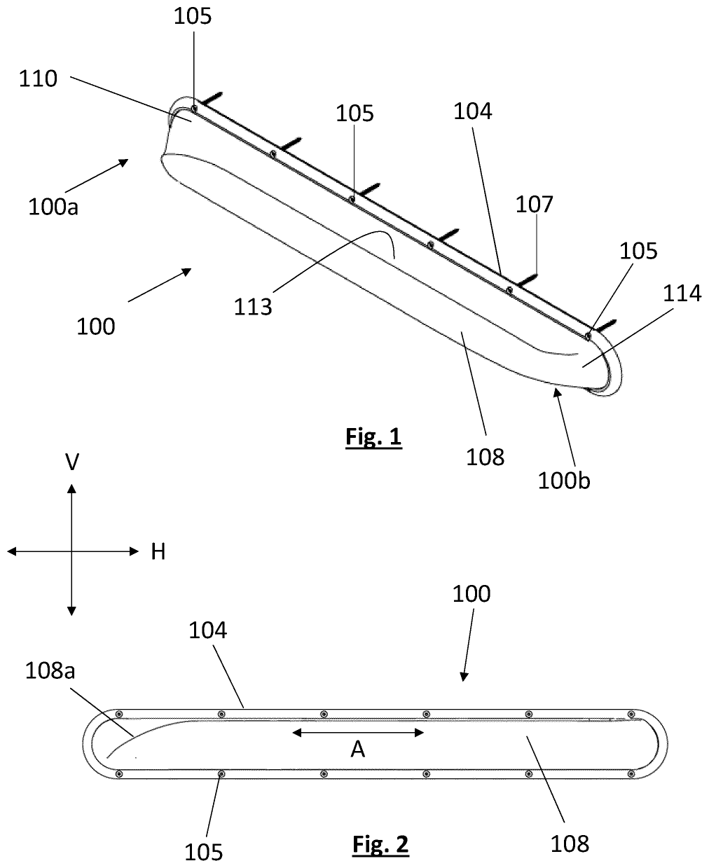

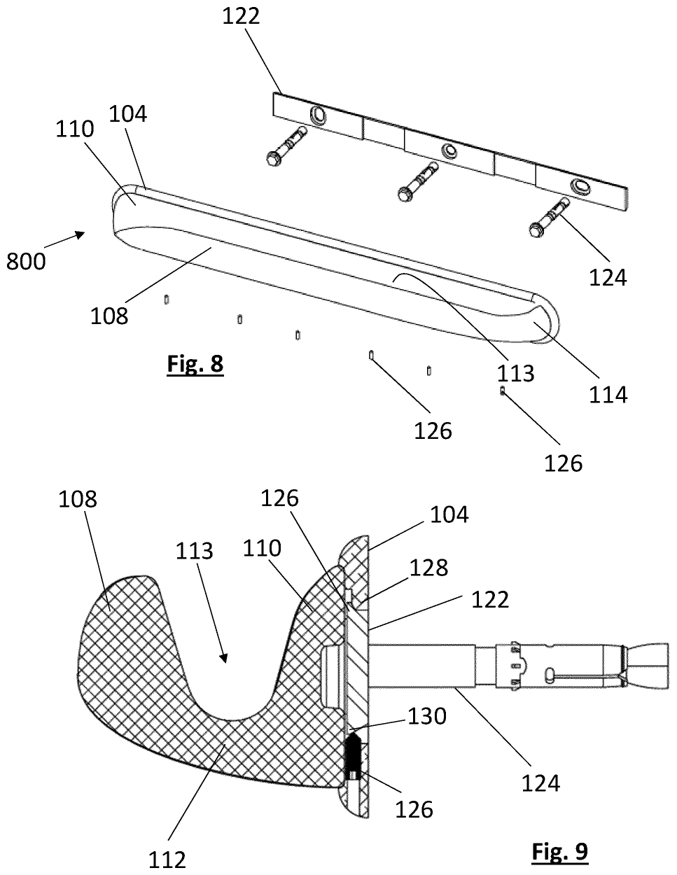

FIGS. 1 to 6 show various views of an assembled hand rail 100 according to a first embodiment of the present disclosure. FIG. 7a shows an exploded view of the hand rail 100. FIG. 7b shows an assembled cross-sectional view of the hand rail 100. Illustrated on FIG. 2 are the vertical direction V, and the horizontal direction H. In the present disclosure, features of the hand rail 100 will be defined relative to these directions. In use, the hand rail 100 may typically be installed in the horizontal orientation as shown in FIG. 2. However, the reader will understand that other orientations are possible. In the horizontal orientation, the major axis A of the elongate handle 108 is oriented horizontally. Where a cross-section is referred to herein, it is defined perpendicular to the axis A.

As shown in FIGS. 7a and 7b, the hand rail 100 includes a first part 102, and a second part (sometimes also referred to herein as a wall plate) 104. The second part 104 is configured for attachment to a wall. For this purpose, the second part 104 is generally planar. In the first embodiment of FIGS. 1-7, the second part 104 includes counter-sunk holes 105 at its perimeter, for attachment to a wall. The first part 102 is attached to the wall plate 104 by threaded screws 106. The wall plate in turn attaches to the wall by threaded screws 107, which pass through the counter-sunk holes 105. As shown in FIG. 7b, the screws 106 which attach the wall plate 104 to the first part 102 are grub screws, and they extend into the first part 102 from a rear side of the wall plate 104. The screws 107 may be wood screws, masonry screws, or drywall screws (as required by the type of wall to which the hand rail 100 is to be attached). The screws 107 screw into the wall from a front edge of the wall plate. Therefore, the grub screws 106 extend in the opposite direction from the screws 107 (the grub screws 106 extend away from the wall and into the first part 102; and the screws 107 extend into the wall). Collectively, the screws 106 and 107 attach the first part 102 to the wall.

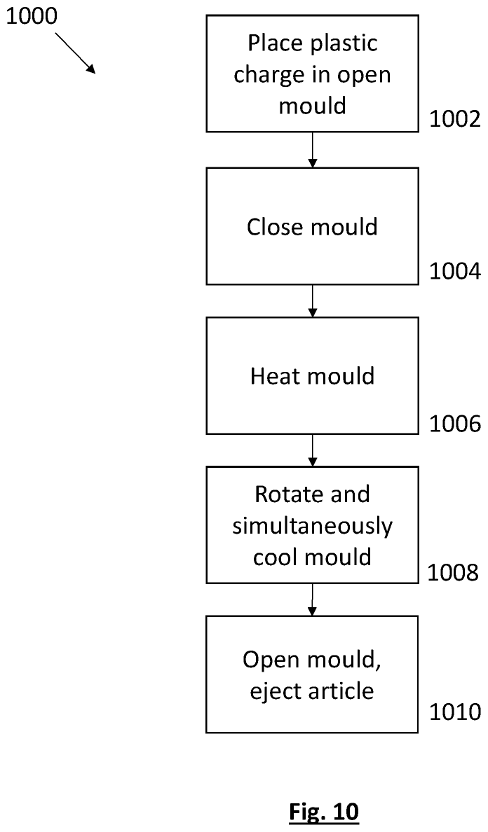

The first part 102 is a single unitary part. The second part 104 is also a single unitary part. The method of manufacture of the first part 102 is described in detail in FIG. 10. Briefly, however, the first part 102 is formed by rotational moulding and is therefore a unitary hollow plastic piece.

As shown in FIGS. 1-7, the first part 102 includes an elongate handle 108, an attachment portion 110, and a continuous connecting web 112. The continuous connecting web 112 connects the hand rail 108 to the attachment portion 110. The web 112 extends from a first end 100a of the hand rail, to the second end 100b of the hand rail. Where a first end of a component is referred to herein, it is to be understood as the end of the component that is nearer the first end 100a of the hand rail. Where a second end of a component is referred to herein, it is to be understood as the end of the component that is nearer the second end 100b of the hand rail.

An elongate channel 113 is defined between the handle 108, the attachment portion 110, and the web 112. The hand rail 100 also includes an end-wall 114 at the second end thereof. The end-wall 114 is an upwardly extending extension of the web 112. Similarly to the web 112, the end-wall 114 connects both to the handle 108 and the attachment portion 110. The end wall 114 acts to close the second end of the channel 113. The channel 113 is open at the first end, so that liquid (e.g. water) can drain from the channel.

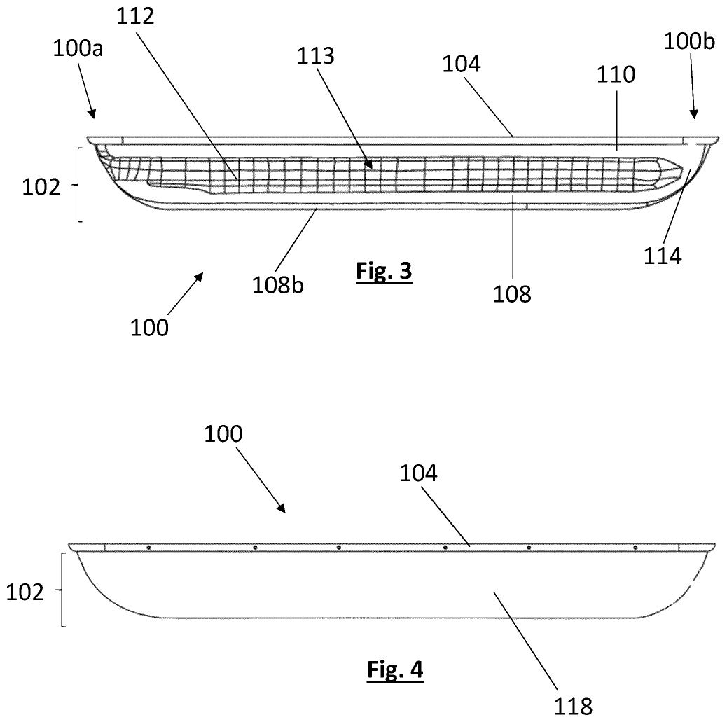

Turning specifically to FIG. 3, the channel as defined between the handle 108 and the attachment portion 110 can be clearly seen. The closing of the second end of the channel 113 by the end-wall 114 can also be clearly seen. Referring still to FIG. 3, it can be seen that the first end 100a and the second end 100b of the hand rail 100 are rounded when viewed from above. That is, the length of the hand rail when viewed above tapers from a largest length at the wall plate 104, to a shortest length at the front edge 108b of the handle 108.

Turning to FIG. 2, a sloped upper edge 108a of the handle 108 can be seen. In particular, towards the first end 100a of the hand rail 100, the upper edge 108a of the handle 108 can be seen to slope downwards. The wall plate 104 is aluminium.

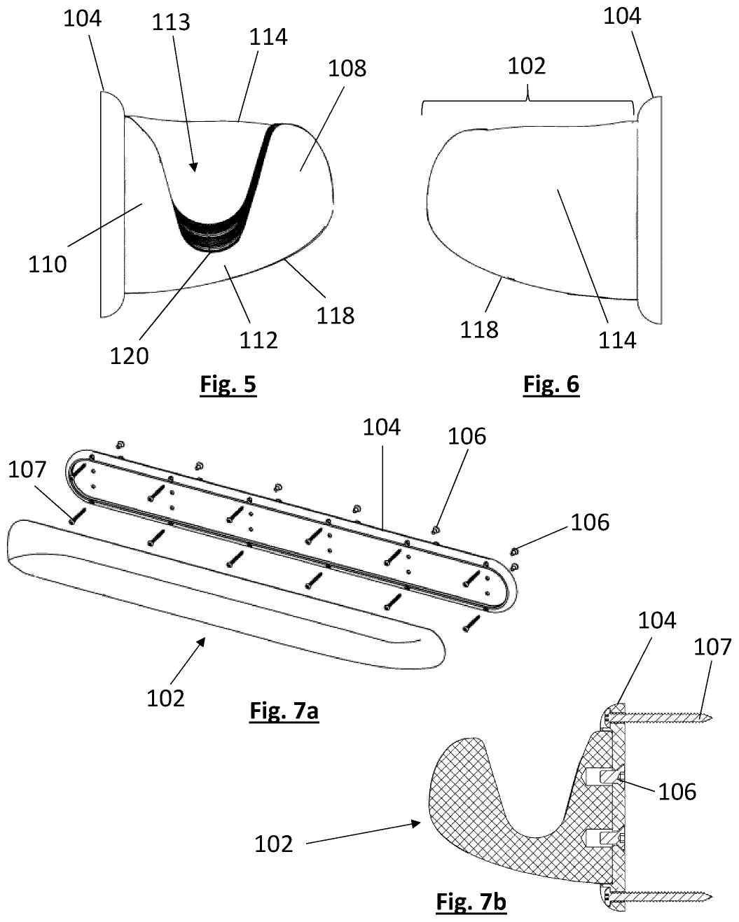

FIGS. 5 and 6 respectively show an end-view from the first end 100a of the hand rail, and an end-view from the second end 100b of the hand rail. The underside 118 of the hand rail 100 can be seen to slope downwards towards the wall plate 104. The underside 118 is convex.

Referring to FIG. 5, the cross-sectional profile of the channel 113 can be seen. The channel 113 is generally v-shaped, with the opposing side-walls forming an acute angle with respect to one another. The channel 113 is sloped downwards towards the open end thereof, such that the base 120 of the channel is lower at the first (open) end than at the second (closed) end. This slope encourages water to drain from the channel. The base 120 of the channel is located generally below the height of the handle 108.

FIGS. 8-9 show a hand rail 800 according to a second embodiment of the present disclosure. The hand rail 800 of the second embodiment is in many respects the same as the hand rail 100 of the first embodiment, as illustrated by the use of like reference numerals for like features of the two embodiments. However, the means of attachment to a wall in the second embodiment is different from that of the first embodiment, as described in more detail below.

To attach the hand rail 800 of the second embodiment to a wall, an attachment plate 122 is first secured to the wall. In the example shown, masonry anchors 124 are used to secure the attachment plate 122 to the wall. Masonry anchors are particularly secure. However, as the reader will understand, a different anchor means may be used in lieu of masonry anchors 124, depending on the situation. Once the attachment plate 122 has been secured to the wall, the hand rail 800 is placed over the attachment plate 122 such that a top edge 126 of the attachment plate 122 hooks behind a corresponding lip 128 of the wall plate 104. Grub screws 126 are then screwed into an underside of the wall plate 104, such that they engage a corresponding lip 130 of the attachment plate 122. With the grub screws 126 in place, the hand rail 800 is securely attached to the wall.

FIG. 10 shows a method 1000 of manufacturing the first part 102 of the hand rail 100, or equivalently the first part 100 of the hand rail 800.

At step 1002, a charge of powdered thermoplastic is placed into an open hollow mould. The hollow mould comprises two parts which, when secured together, define an internal cavity with a surface profile which matches the surface profile of the hand rail to be manufactured.

At step 1004, the mould is closed, thereby sealing the internal cavity with the powdered thermoplastic inside.

At step 1006, the mould is heated to a temperature that is greater than the melting temperature of the thermoplastic. The plastic is thereby caused to melt.

As step 1008, the mould is rotated about two perpendicular axes, thereby dispersing the melted plastic over the inner surfaces of the mould's cavity. Simultaneously, the mould is gradually cooled, thereby cooling and solidifying the plastic in contact with the inner surfaces of the mould. Accordingly, the plastic sticks to the inner surfaces of the mould, and assumes the 3D shape of the cavity.

At step 1010, the mould is opened and the formed hollow hand rail (hollow first part 102) article is ejected.

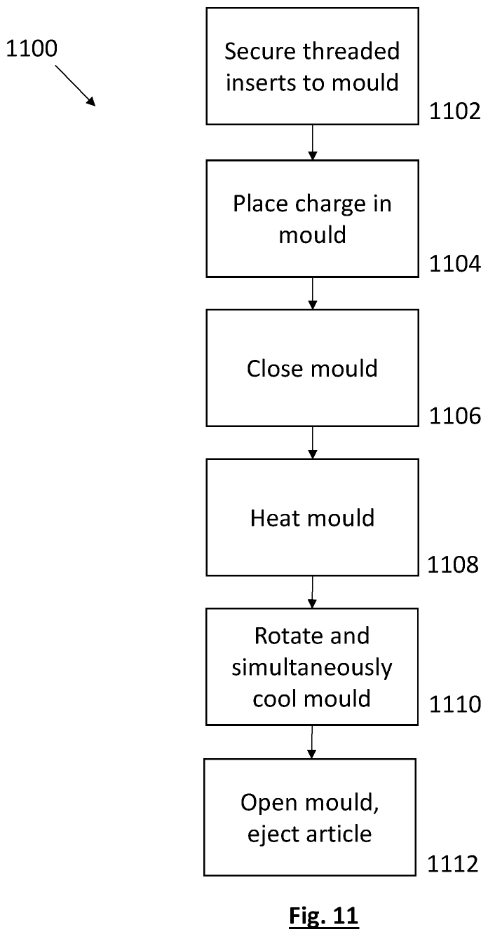

FIG. 11 shows an alternative method 1100 of manufacturing the first part 102 of the hand rail 100.

At step 1102, a user opens a hollow mould, to reveal an internal cavity of the hollow mould. The hollow mould comprises two parts which, when secured together, define an internal cavity with a surface profile which matches the surface profile of the hand rail to be manufactured. Once opened, the user affixes a plurality of threaded inserts to the internal cavity surface profile of the hollow mould, such that a threaded opening of each threaded insert is in contact with the surface profile. An adhesive may be used to retain the threaded inserts in place. Alternatively, the threaded inserts may be secured to the surface profile by another means, for example by clamping or threading (using machine screws) onto the surface profile.

At step 1104, the user places a charge of thermoplastic into the open hollow mould.

At step 1106, the user closes the hollow mould, thereby sealing the internal cavity with the powdered thermoplastic inside.

At step 1108, the mould is heated to a temperature that is greater than the melting temperature of the thermoplastic. The plastic is thereby caused to melt.

At step 1110, the mould is rotated about two perpendicular axes, thereby spreading the melted plastic over the inner surfaces of the mould's cavity and the over the threaded inserts. Simultaneously, the mould is gradually cooled, thereby cooling and solidifying the plastic in contact with the inner surfaces of the mould and the threaded inserts. Accordingly, the plastic sticks to the inner surfaces of the mould, and assumes the 3D surface profile shape of the cavity.

At step 1112, the mould is opened and the formed hollow hand rail article (first part 102) is ejected.

By securing the threaded inserts to the surface profile of the mould at step 1102 (prior to performing the rotational moulding steps at steps 1108-1112), the threaded inserts become embedded in the walls of the hollow hand rail article (the walls of the first part 102) during the rotational moulding. In particular, the threaded inserts become embedded into the rear surface of the attachment portion 110 of the first part 102, with the threaded openings of the threaded inserts exposed at the rear surface. Accordingly, the attachment between the attachment portion 110 and the threaded inserts 1200 is strong. Additionally, no through-holes need to be formed in the first part 102, which again improves strength of the first part 102, while at the same time helping to eliminate ligature points and helping to provide a smooth surface profile to help with sanitation.

In a variation of the method shown in FIG. 10 or in FIG. 11, the mould may be closed before inserting the thermoplastic; and the thermoplastic may be pumped into the closed mould in either powdered form, or molten form.

FIG. 12 shows the resulting internal arrangement of threaded inserts 1200 embedded in an outer wall 1202 of the first part 102 (in particular, within a rear surface of the attachment portion 110 of the first part 102). As shown, the threaded inserts 1200 are embedded in the outer wall 1202 of the first part 102 (in particular, embedded within the outer wall of the attachment portion 110). The threaded openings of the threaded inserts are substantially flush with the rear surface and are exposed. As such threaded screws can be inserted into the threaded inserts for attachment purposes. Outer surface 1204 of the first part 102 is labelled for illustrative purposes. Outer surface 1204 is the surface which contacts the second part 104 in the assembled hand rail 100 of FIGS. 1-7. As can be seen, the threaded inserts 1200 are completely embedded in the bulk 1202a of the outer wall 1202. The threaded inserts 1200 are threaded for receiving the threaded screws 106.

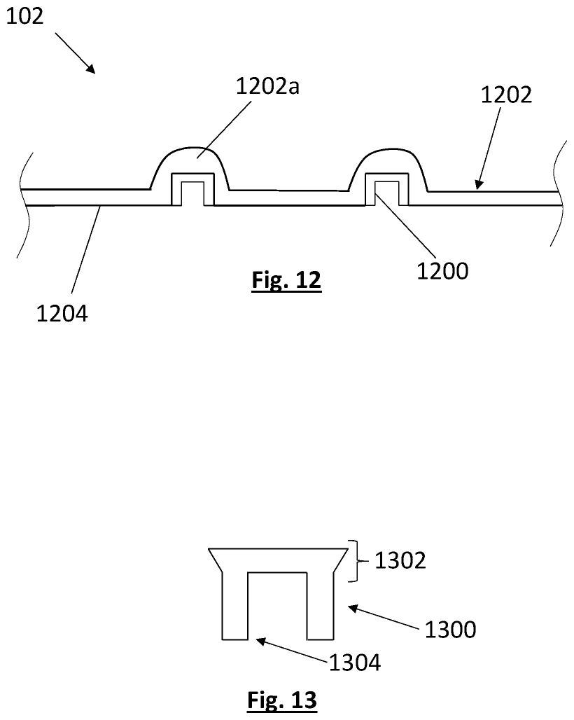

FIG. 13 shows a further example of an threaded insert 1300 for use in first part 102 according to a further embodiment. As shown in FIG. 13, threaded insert 1300 includes an overhang 1302, the overhang being distal from the opening 1304 of the threaded insert and having an outer diameter which is larger than the outer diameter of the threaded insert 1300 at the opening. The overhand helps to improve the security of the threaded insert the outer wall 1202 and the threaded insert 1300, by creating a secure keyed engagement between the threaded insert 1300 and the bulk 1202a of the outer wall 1202.

In some examples, the hollow hand rail may be filled with a material, such as polyurethane foam, to improve structural rigidity. The filling may be done by injection.

In some examples, an antimicrobial plastic, such as Microban®, may be used as the outer material of the hand rail.

In some examples, the outer wall of the grab bar may be formed of polyethylene.

It is to be understood that the above description is intended to be illustrative, and not restrictive. Many other implementations will be apparent to those of skill in the art upon reading and understanding the above description. Although the present disclosure has been described with reference to a specific example implementation, it will be recognized that the disclosure is not limited to the implementations described, but can be practiced with modification and alteration insofar as such modification(s) and alteration(s) remain within the scope of the appended claims. For example, a mirror image of the hand rail as described above also falls within the scope of the present disclosure. Accordingly, the specification and drawings are to be regarded in an illustrative sense rather than a restrictive sense. The scope of the disclosure should, therefore, be determined with reference to the appended claims, along with the full scope of equivalents to which such claims are entitled according to the doctrine of equivalents.

1. A hand rail comprising:
an elongate handle and an attachment portion, the handle being connected to the attachment portion by a continuous connecting web that extends from a first end of the hand rail to a second end of the hand rail to define an elongate channel between the handle and the attachment portion, the channel being open at the first end of the handle and closed at the second end of the handle;
wherein a base of the channel is sloped relative to the handle such that liquid drains out of the channel when the handle is in a horizontal orientation.

2. The hand rail of claim 1, wherein the handle and attachment portion collectively comprise a unitary part formed of plastic.

3. The hand rail of claim 1, further comprising a wall plate attached to the attachment portion, wherein the handle and attachment portion collectively comprise a first unitary part, and wherein the wall plate comprises a second unitary part attached to the first unitary part.

4. A hand rail comprising:
an elongate handle, an attachment portion, and a wall plate attached to the attachment portion, the handle being connected to the attachment portion by a continuous connecting web that extends from a first end of the hand rail to a second end of the hand rail to define an elongate channel between the handle and the attachment portion, the channel being open at the first end of the handle and closed at the second end of the handle;
wherein the handle and attachment portion collectively comprise a first unitary part, and wherein the wall plate comprises a second unitary part attached to the first unitary part.

5. The hand rail of claim 4, wherein the first unitary part is formed of plastic.

6. A hand rail comprising:
an elongate handle and an attachment portion, the handle being connected to the attachment portion by a continuous connecting web that extends from a first end of the hand rail to a second end of the hand rail to define an elongate channel between the handle and the attachment portion, the channel being open at the first end of the handle and closed at the second end of the handle;
wherein the handle and attachment portion collectively comprise a unitary part formed of plastic.

7. The hand rail of claim 1, wherein the handle and attachment portion are formed as a single piece.

8. The hand rail of claim 1, wherein the handle and attachment portion are formed by rotational moulding.

9. The hand rail of claim 1, comprising a top edge and a bottom edge when affixed horizontally along a wall, wherein the channel extends below the handle.

10. The hand rail of claim 9, wherein an underside of the hand rail slopes downwards towards the wall.

11. The hand rail of claim 10, wherein the underside of the hand rail is convex in cross-section.

12. The hand rail of claim 9, wherein a top edge of the handle slopes downwards towards the first end.

13. The hand rail of claim 1, wherein the length of the hand rail tapers towards a front edge of the elongate handle.

14. The hand rail of claim 1, wherein a cross-sectional width of the channel tapers towards the base of the channel.

15. The hand rail of claim 1, wherein the channel is V-shaped in cross-section.

16. The hand rail of claim 1, wherein the first and second ends of the hand rail are rounded.

17. The hand rail of claim 1, further comprising threaded inserts embedded into a rear surface of the attachment portion.

18. The hand rail of claim 17, wherein the threaded inserts are keyed into the attachment portion.

19. (canceled)

20. A method of manufacturing the hand rail of claim 1 comprising the steps of:
filling a hollow mould with a charge of thermoplastic;
closing the mould;
heating the mould to melt the thermoplastic; and
cooling the mould while simultaneously rotating the mould, to thereby coat the inner surfaces of the mould with the plastic.

21. The handrail manufactured according to the method of claim 20, wherein the method further comprises, prior to closing the mould, attaching a plurality of threaded inserts to an inner surface of the mould, such that the threaded inserts become embedded in the plastic as the plastic coats the inner surfaces of the mould.
